(19) United States
(12) Patent Application Publication
(10) Pub. No.: US 2023/0360385 A1
(43) Pub. Date: Nov. 9, 2023

(54) DEEP LEARNING BASED OBJECT IDENTIFICATION AND/OR CLASSIFICATION

(71) Applicant: City University of Hong Kong, Kowloon (HK)

(72) Inventors: Ho Sang Lam, Kowloon (HK); Wai Ming Peter Tsang, Kowloon (HK)

(21) Appl. No.: 18/170,621

(22) Filed: Feb. 17, 2023

(30) Foreign Application Priority Data
May 3, 2022 (HK) 32022052865.9

(51) Int. Cl. G06V 10/82; G03H 1/16; G06V 10/46

(52) U.S. Cl. CPC G06V 10/82; G03H 1/16; G06V 10/478; G06V 2201/03

(57) ABSTRACT

A computer-implemented method and a system for object identification and/or classification. The computer-implemented method includes receiving digital hologram data of a digital hologram of an object. The digital hologram data comprises phase information and magnitude information. The computer-implemented method further includes processing the digital hologram data based on a neural-network-based ensemble model to identify and/or classify the object.

### TECHNICAL FIELD

The invention generally relates to deep learning based object identification and/or classification systems and methods. The object identification and/or classification is based on wavefront identification and/or classification.

### BACKGROUND

Accurate identification and/or classification of wavefront originating from an object can be difficult as the appearance of the wavefront usually provides little or no information on the object to which the wavefront relates.

### SUMMARY OF THE INVENTION

In a first aspect, there is provided a computer-implemented method for object identification and/or classification, comprising: receiving digital hologram data of a digital hologram of an object, and processing the digital hologram data based on a neural-network-based ensemble model to identify and/or classify the object (based on its wavefront that can be arranged in the format of the digital hologram). The digital wavefront data comprising phase information and magnitude information. Examples of the neural-network-based ensemble model include convolutional-neural-network-based ensemble model, attention based transformer model, etc. Other neural-network-based ensemble models for feature extractions may be used.

Optionally, the neural-network-based ensemble model comprises a first neural network arranged to process the magnitude information to extract magnitude features, a second neural network arranged to process the phase information to extract phase features, and a concatenate unit arranged to combine magnitude features extracted by the first neural network and phase features extracted by the second neural network for identification and/or classification of the object.

Optionally, the neural-network-based ensemble model comprises a convolutional-neural-network-based ensemble model, which comprises a first convolutional neural network arranged to process the magnitude information to extract magnitude features, a second convolutional neural network arranged to process the phase information to extract phase features, and a concatenate unit arranged to combine magnitude features extracted by the first convolutional neural network and phase features extracted by the second convolutional neural network for identification and/or classification of the object.

Preferably, the object comprises a sample, such as a biological sample or a biological tissue sample. The biological sample or a biological tissue sample may be a sample suitably sized or otherwise arranged for microscopy. The biological sample or the biological tissue sample may be incomplete, damaged, or flawed.

Optionally, the object comprises a non-biological sample.

In one example, the computer-implemented method is performed during training/testing/validation stage to train/test/validate the model. The testing/training/validation data may include digital wavefront data of multiple digital wavefronts of each object that the model is to be used to identify and/or classify. In some examples, at least some of the digital wavefront data of the testing/training/validation data may be defective or flawed or incomplete to improve the identification and/or classification performance (e.g., accuracy) of the model. In another example, the computer-implemented method is performed during inference stage to identify and/or classify an object.

Optionally, the computer-implemented method further comprises outputting or displaying the identification and/or classification result.

Optionally, the computer-implemented method further comprises obtaining the digital hologram data of the digital hologram of the object, the obtaining comprises: receiving a hologram of the object obtained using an imaging device; and processing the hologram by performing a digital signal processing operation to obtain the digital hologram data.

Optionally, the imaging device may be a wavefront capturing device, e.g. a digital wavefront capturing device. The imaging device may comprise a camera associated with an interferometer. For example, the camera may be a CCD or CMOS camera. For example, the interferometer may be a Mach-Zehnder interferometer (which may serve as a digital holographic microscope). For example, a lens (e.g., a microscopic objective lens) may be placed between the camera and the interferometer. For example, the light source associated with the interferometer may be a coherent light source, e.g., a laser source.

Optionally, the hologram is an off-axis hologram and the interferometer is an off-axis interferometer.

Optionally, the digital signal processing operation comprises: performing a Fourier transform operation on the hologram; after the Fourier transform operation, extracting hologram data associated with the object; and after the extraction, performing an inverse Fourier transform operation on the extracted hologram data to obtain the digital hologram data.

Optionally, the digital hologram data is associated with an electromagnetic wavefront from the object.

Optionally, the digital hologram data is associated with an acoustic wavefront from the object.

In a second aspect, there is provided a system for object identification and/or classification comprising one or more processors arranged (e.g., programmed) to: receive digital hologram data of a digital hologram of an object, and process the digital hologram data based on a neural-network-based ensemble model to identify and/or classify the object (based on its wavefront that can be arranged in the format of the digital hologram). The digital wavefront data comprises phase information and magnitude information. Examples of the neural-network-based ensemble model include convolutional-neural-network-based ensemble model, attention based transformer model, etc. Other neural-network-based ensemble models for feature extractions may be used.

Optionally, the neural-network-based ensemble model comprises a first neural network arranged to process the magnitude information to extract magnitude features, a second neural network arranged to process the phase information to extract phase features, and a concatenate unit arranged to combine magnitude features extracted by the first neural network and phase features extracted by the second neural network for identification and/or classification of the object.

Optionally, the neural-network-based ensemble model comprises a convolutional-neural-network-based ensemble model, which comprises a first convolutional neural network arranged to process the magnitude information to extract magnitude features, a second convolutional neural network arranged to process the phase information to extract phase features, and a concatenate unit arranged to combine magnitude features extracted by the first convolutional neural network and phase features extracted by the second convolutional neural network for identification and/or classification of the object. The system may be used to perform training/testing/validation of the model and/or inference using the model. The one or more processors may be arranged on one or more information handling systems and/or computing devices.

Preferably, the object comprises a sample, such as a biological sample or a biological tissue sample. The biological sample or a biological tissue sample may be a sample suitably sized or otherwise arranged for microscopy. The biological sample or the biological tissue sample may be incomplete, damaged, or flawed.

Optionally, the object comprises a non-biological sample.

Optionally, the system further comprises a display operably connected with the one or more processors for displaying the identification and/or classification result.

Optionally, the one or more processors are further arranged to: receive a hologram of the object obtained using an imaging device; and process the hologram by performing a digital signal processing operation to obtain the digital hologram data.

Optionally, the system further comprises the imaging device, which may be a wavefront capturing device, e.g. a digital wavefront capturing device. Optionally, the imaging device comprises a camera associated with an interferometer. For example the camera may be a CCD or CMOS camera. For example, the interferometer may be a Mach-Zehnder interferometer (which may serve as a digital holographic microscope). For example, a lens (e.g., a microscopic objective lens) may be placed between the camera and the interferometer. For example, the light source associated with the interferometer may be a coherent light source, e.g., a laser source. Optionally, the system further comprises the interferometer.

Optionally, the hologram is an off-axis hologram and the interferometer is an off-axis interferometer.

Optionally, the one or more processors are arranged to: perform a Fourier transform operation on the off-axis hologram; extract hologram data associated with the object; and perform an inverse Fourier transform operation on the extracted hologram data to obtain the digital hologram data.

Optionally, the digital hologram data is associated with an electromagnetic wavefront from the object. Optionally, the digital hologram data is associated with an acoustic wavefront from the object.

In a third aspect, there is provided a computer readable medium, such as a non-transitory computer readable medium, comprising computer instructions which, when executed by one or more processors, cause or facilitate the one or more processors to carry out the method of the first aspect. The one or more processors may include multiple processors arranged in a single device/apparatus or distributed in multiple devices/apparatuses.

In a fourth aspect, there is provided a computer program comprising instructions which, when the computer program is executed by one or more processors, cause or facilitate the one or more processors to carry out the method of the first aspect.

In a fifth aspect, there is provided a data processing apparatus comprising means for carrying out the method of the first aspect.

In a sixth aspect, there is provided a neural-network-based ensemble model of the first aspect. Examples of the neural-network-based ensemble model include convolutional-neural-network-based ensemble model, attention based transformer model, etc.

As used herein, unless otherwise specified: “hologram”, “raw hologram”, or “interference hologram” refers to the interference intensity map recorded on camera or a film, and this intensity map can be used for the object wavefront reconstruction; “digital hologram” refers to the representation of the complex (value) optical wavefront diffracted from an object, which may be generated directly by a computer or reconstructed digitally from a “hologram”, “raw hologram”, or “interference hologram” as appropriate and applicable. As used herein, unless otherwise specified, the expressions “raw hologram” and “interference hologram” are used interchangeably. A computer-generated hologram can also be referred to as wavefront-based computer-generated hologram.

In various embodiments of the invention, the wavefront or object wavefront can be represented by array(s) of complex numbers and digital holography can be used to capture the electromagnetic wavefront at light frequencies (e.g., optical wavefront) such that the captured information is in the format of a digital hologram.

Terms of degree such that “generally”, “about”, “substantially”, or the like, are used, depending on context, to account for manufacture tolerance, degradation, trend, tendency, practical applications, etc. In some examples, when a value is modified by terms of degree, such as “about”, such expression includes the stated value ±15%, ±10%, ±5%, ±2%, or ±1%.

Unless otherwise specified, the terms “connected”, “coupled”, “mounted” or the like, are intended to encompass both direct and indirect connection, coupling, mounting, etc.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF THE DRAWINGS

Embodiments of the invention will now be described, by way of example, with reference to the accompanying drawings in which:

FIG. 1 is a schematic diagram of a system for object identification and/or classification in some embodiments of the invention;

FIG. 2 is a functional block diagram of the machine learning controller in the system of FIG. 1;

FIG. 3 is a function block diagram of an information/data handling system in some embodiments of the invention;

FIG. 4A is a schematic diagram of an interferometer system in one embodiment of the invention;

FIG. 4B is a schematic diagram of an interferometer system in one embodiment of the invention;

FIG. 5A is a schematic diagram of a general neural-network-based ensemble model for object identification and/or classification in some embodiments of the invention;

FIG. 5B is a schematic diagram of a convolutional-neural-network-based ensemble model in one embodiment of the invention, as an example of the model of FIG. 5A, with some components of the convolutional neural networks illustrated;

FIG. 6A is a schematic diagram of the convolutional-neural-network-based ensemble model of FIG. 5A;

FIG. 6B is another schematic diagram of the convolutional-neural-network-based ensemble model of FIG. 5A;

FIG. 7 is a flow diagram of a method for processing hologram of a biological sample in one embodiment of the invention;

FIG. 8A is an image of a Cucurbita stem sample that can be used for training the neural-network-based ensemble model of FIG. 5A in one embodiment of the invention;

FIG. 8B is an image of a pine stem sample that can be used for training the neural-network-based ensemble model of FIG. 5A in one embodiment of the invention;

FIG. 8C is an image of a corn (Zea mays) seed sample that can be used for training the neural-network-based ensemble model of FIG. 5A in one embodiment of the invention;

FIG. 8D is an image of a house fly wing sample that can be used for training the neural-network-based ensemble model of FIG. 5A in one embodiment of the invention;

FIG. 8E is an image of a honeybee wing sample that can be used for training the neural-network-based ensemble model of FIG. 5A in one embodiment of the invention;

FIG. 8F is an image of a bird feather sample that can be used for training the neural-network-based ensemble model of FIG. 5A in one embodiment of the invention;

FIG. 8G is an image of a corpus ventriculi sample that can be used for training the neural-network-based ensemble model of FIG. 5A in one embodiment of the invention;

FIG. 8H is an image of a liver section sample that can be used for training the neural-network-based ensemble model of FIG. 5A in one embodiment of the invention;

FIG. 8I is an image of a lymph node sample that can be used for training the neural-network-based ensemble model of FIG. 5A in one embodiment of the invention;

FIG. 8J is an image of a human chromosome sample that can be used for training the neural-network-based ensemble model of FIG. 5A in one embodiment of the invention;

FIG. 9A is an image showing an interference hologram associated with data of the bird feather sample in one embodiment of the invention;

FIG. 9B is an image showing spectrums in Fourier space associated with data of the bird feather sample in one embodiment of the invention;

FIG. 9C is an image showing a clipped spectrum of the object real image associated with data of the bird feather sample in one embodiment of the invention;

FIG. 9D is an image showing magnitude component of the object wavefront associated with data of the bird feather sample in one embodiment of the invention;

FIG. 9E is an image showing phase component of the object wavefront associated with data of the bird feather sample in one embodiment of the invention;

FIG. 9F is an image showing a reconstructed tissue intensity image associated with data of the bird feather sample in one embodiment of the invention;

FIG. 10A is an image of a human chromosome sample used in an experiment in one embodiment of the invention;

FIG. 10B is an image showing an interference hologram of the human chromosome sample of FIG. 10A;

FIG. 10C is a reconstructed tissue image of the human chromosome sample of FIG. 10A;

FIG. 10D is a full frequency spectrum plot associated with data of the human chromosome sample of FIG. 10A;

FIG. 10E is a clipped frequency spectrum plot associated with data of the human chromosome sample of FIG. 10A;

FIG. 10F is a plot of the magnitude component of the complex object wavefront associated with data of the human chromosome sample of FIG. 10A;

FIG. 10G is a plot of the phase component of the complex object wavefront associated with data of the human chromosome sample of FIG. 10A;

FIG. 11A is an image of a house fly wing sample used in an experiment in one embodiment of the invention;

FIG. 11B is an image showing an interference hologram of the house fly wing sample of FIG. 11A;

FIG. 11C is a reconstructed tissue image of the house fly wing sample of FIG. 11A;

FIG. 11D is a full frequency spectrum plot associated with data of the house fly wing sample of FIG. 11A;

FIG. 11E is a clipped frequency spectrum plot associated with data of the house fly wing sample of FIG. 11A;

FIG. 11F is a plot of the magnitude component of the complex object wavefront associated with data of the house fly wing sample of FIG. 11A;

FIG. 11G is a plot of the phase component of the complex object wavefront associated with data of the house fly wing sample of FIG. 11A; and

FIG. 12 is a plot illustrating the confusion matrix associated with the identification/classification performance of the convolutional-neural-network-based ensemble model of FIG. 5B in one example.

### DETAILED DESCRIPTION

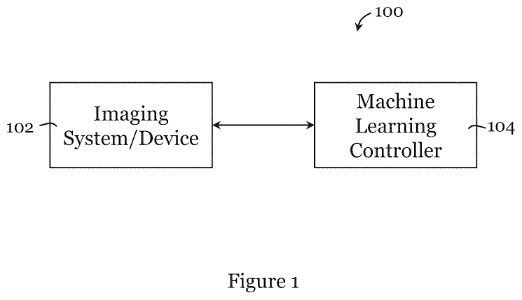

FIG. 1 shows a system 100 for object identification and/or classification in some embodiments of the invention. The system 100 includes an imaging system/device 102 and a machine learning controller 104 operably connected with each other. The machine learning controller 104 may or may not be part of the imaging system/device 102. In some embodiments, the object is a biological object, e.g., a biological sample or a biological tissue sample. For example, the biological sample or a biological tissue sample may be suitable (e.g., sized) for microscopy. The biological sample or the biological tissue sample may or may not be incomplete, damaged, or flawed. In some other embodiments, the object can be a non-biological object.

The imaging system/device 102 may be any imaging system device arranged to obtain a wavefront (e.g., electromagnetic wavefront) associated with a biological object captured or imaged by the imaging system/device. The imaging system/device may thus be considered as a wavefront capturing device, e.g., a digital wavefront capturing device. For example, the imaging system/device may include an interferometer (e.g., a Mach-Zehnder interferometer, an off-axis interferometer), a camera (e.g., CMOS camera, CCD camera), an MRI imaging system/device, etc. In one example in which the imaging system/device 102 includes a camera, the camera may be associated with an interferometer, optionally with a lens (e.g., a microscopic objective lens) placed between the camera and the interferometer.

The machine learning controller 104 is arranged to receive digital hologram data of a digital hologram of a biological object, and process the digital hologram data using a neural-network-based ensemble model to identify and/or classify the object (based on its wavefront that can be arranged in the format of the digital hologram). The neural-network-based ensemble model may be a model initialized, or being trained, or a model that has been trained. The digital hologram or digital hologram data may be obtained directly from the imaging system/device 102, or may be obtained by processing hologram or hologram data obtained from the imaging system/device 102. The digital hologram data may be associated with an electromagnetic wavefront from the object, an acoustic wavefront from the object, other wave-field information from the object, etc. The digital wavefront data has phase information and magnitude information. The neural-network-based ensemble model may include a convolutional-neural-network-based ensemble model, an attention based transformer model, etc.

In some embodiments, the neural-network-based ensemble model has a first neural network arranged to process the magnitude information to extract magnitude features, a second neural network arranged to process the phase information to extract phase features, and a concatenate unit arranged to combine magnitude features extracted by the first neural network and phase features extracted by the second neural network for identification and/or classification of the object. The machine learning controller 104 may be operably connected with a display to display the identification and/or classification result.

As a more specific example, the neural-network-based ensemble includes a convolutional-neural-network-based ensemble model, which has a first convolutional neural network arranged to process the magnitude information to extract magnitude features, a second convolutional neural network arranged to process the phase information to extract phase features, and a concatenate unit arranged to combine magnitude features extracted by the first convolutional neural network and phase features extracted by the second convolutional neural network for identification and/or classification of the object. The machine learning controller 104 may be operably connected with a display to display the identification and/or classification result.

In one embodiment, the digital hologram may be obtained be processing a hologram or interference hologram obtained from the imaging system/device 102. The processing may be performed at the imaging system/device 102, at the machine learning controller 104, or partly at the imaging system/device 102 and partly at the machine learning controller 104. The processing may include receiving a hologram of the object obtained using an imaging device and processing the hologram by performing a digital signal processing operation to obtain the digital hologram data. The digital signal processing operation may involve, among other operations, performing a Fourier transform operation on the off-axis hologram; extracting hologram data associated with the object; and performing an inverse Fourier transform operation on the extracted hologram data to obtain the digital hologram data. The hologram may be an off-axis hologram obtained from an off-axis interferometer.

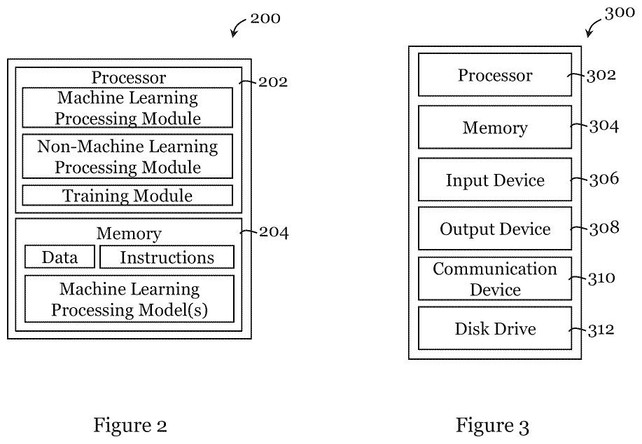

FIG. 2 shows a functional block diagram of a machine learning controller 200 in some embodiments of the invention. The machine learning controller 200 can be used, e.g., as the machine learning controller 104 in the system 100 of FIG. 1. The following description describes an example of how the machine learning controller 200 can be used in the system 100 of FIG. 1. It should be appreciated that the machine learning controller 200 may be used in object identification and/or classification systems other than that of FIG. 1.

In some embodiments, the machine learning controller 200 generally includes a processor 202 and a memory 204. The processor 202 may include one or more of: CPU(s), MCU(s), controller(s), logic circuit(s), Raspberry Pi chip(s), digital signal processor(s) (DSP), application-specific integrated circuit(s) (ASIC), Field-Programmable Gate Array(s) (FPGA), or any other digital or analog circuitry/circuitries configured to interpret and/or to execute program instructions and/or to process information and/or data. The memory 204 may include one or more volatile memory unit(s) (such as RAM, DRAM, SRAM), one or more non-volatile memory unit(s) (such as ROM, PROM, EPROM, EEPROM, FRAM, MRAM, FLASH, SSD, NAND, and NVDIMM), or any of their combinations. The machine learning controller 200 is specifically configured to perform object identification and/or classification, e.g., biological object, identification and/or classification.

The processor 202 includes a machine learning processing module and a non machine learning processing module. The machine learning processing module is arranged to process digital hologram data (using one or more machine learning processing models, such as the neural-network-based ensemble model(s) (convolution-neural-network-based ensemble model(s), attention based transformer model(s), etc.) described above with reference to FIG. 1. In some embodiments, the machine learning processing model may determine a class of an object based on phase information and magnitude information in digital hologram data associated with a digital hologram of an object. The non machine learning processing module is arranged to process data without using machine learning processing models or methods. For example, the non machine learning processing module may be used to perform various signal processing such as filtering, segmenting, thresholding, averaging, smoothing, padding, transforming, scaling, Fourier-based transform (including Fourier transform and inverse Fourier transform), digital signal processing, etc. The non machine learning processing module may process hologram data of a hologram obtained from the imaging system/device 102 to obtain the digital hologram data, which can then be processed using the machine learning processing module and the neural-network-based ensemble model to identify and/or classify the object. The processing of the hologram data to obtain digital hologram data may include the digital signal processing operation described above with reference to FIG. 1. The processor 202 also includes a training module arranged to train the machine learning processing model(s) used for object identification and/or classification, such as the model(s) stored in the memory 204.

The memory 204 may store one or more machine learning processing models to be used by the processor 202 for processing digital hologram data. The one or more machine learning processing models may be used for object identification and/or classification. In one example, only one machine learning processing model is stored. In another example, multiple machine learning processing models are stored. Each machine learning processing model may correspond to a respective identification and/or classification task. The stored machine learning processing model(s) may be trained, re-trained, or updated. New or modified machine learning processing model(s) may be obtained by training or by data transfer (storing in or loading into the machine learning controller 200). The memory 204 also stores data and instructions. The data may include training/validation/test data for training/validating/testing the machine learning processing model(s), data (e.g., hologram/wavefront data, digital hologram/wavefront data, etc.) received from external devices such as the imaging system/device 102, etc. The training/validation/test data used to train/validate/test the respective machine learning processing model(s) may be identified and/or classified based on identification and/or classification task. The instructions include commands, codes, etc., that can be used by the processor 202 to operate the machine learning controller 200.

The machine learning controller 200, with the training module, can initialize, construct, train, and/or operate the one or more machine learning processing models (e.g., algorithms), such as those stored in the memory 204. In one embodiment, the machine learning processing model(s) can be initialized, constructed, trained, and/or operated based on supervised learning. The machine learning controller 200 can be presented with example input-output pairs, e.g., formed by example inputs (e.g., digital wavefront/hologram data of a digital wavefront/hologram of an object) and their actual outputs (e.g., the class of the object), which may be stored in memory 204, to learn a rule or model that maps the inputs to the outputs based on the provided example input-output pairs. Different machine learning processing models may be trained differently, using different machine learning methods, input and output data, etc., to suit specific identification and/or classification task or application. For example, the training examples/data used to train the machine learning processing models may include different information and may have different dimensions based on the task to be performed by the machine learning processing models. In some embodiments, the machine learning controller 200 is arranged to perform object identification and/or classification using the neural-network-based ensemble model. In other embodiments, additionally or alternatively, the machine learning controller 200 may perform object identification and/or classification based on digital wavefront/hologram data using a different machine learning based model, such as a recurrent neural network, a long-short term memory model, Markov process, reinforcement learning, gated recurrent unit model, deep neural network, convolutional neural network, support vector machines, decision trees/forest, ensemble method (combining model), stochastic gradient descent, linear discriminant analysis, nearest neighbor classification, naive Bayes, etc. Each machine learning processing model can be trained to perform a particular object identification and/or classification task. The machine learning processing model can be trained to identify, based on input data (e.g., digital wavefront/hologram data of a digital wavefront/hologram of an object), an estimated class of the object.

As mentioned, training examples are provided to the machine learning controller 200, which uses them to generate or train a model (e.g., a rule, a set of equations, and the like), i.e., a machine learning processing model that helps categorize or estimate an output based on new input data. The machine learning controller 200 may weigh different training examples differently, e.g., to prioritize different conditions or outputs. The training module may train the model(s) at regular intervals or after accumulating a set amount of data. In one embodiment, the machine learning processing model includes a neural-network-based ensemble model. The model may be a convolutional-neural-network-based ensemble model that includes two convolutional neural networks, one arranged to process phase information of digital wavefront/hologram data and another arranged to process magnitude information of the digital wavefront/hologram data, as well as a concatenate unit arranged to combine magnitude features extracted by the first convolutional neural network and phase features extracted by the second convolutional neural network for identification and/or classification of the object. In one embodiment, each of the convolutional neural networks includes an input layer and one or more hidden layers or nodes, and the concatenate unit includes a concatenate layer, one or more hidden layers or nodes, and an output layer. The number of inputs hence nodes in the input layer of the convolutional neural networks may vary based on the particular identification and/or classification task. For each of the convolutional neural networks and the concatenate unit, the number of hidden layers may vary and may depend on the particular identification and/or classification task. Each hidden layer may have a different number of nodes and may be connected to the adjacent layer in a different manner. For example, each node of the input layer may be connected to each node of the first hidden layer, and the connections may each be assigned a respective weight parameter. In one example, each node of the neural network may also be assigned a bias value. The nodes of the first hidden layer may not be connected to each node of the second hidden layer, and again, the connections are each assigned a respective weight parameter. Each node of the hidden layer may be associated with an activation function that defines how the hidden layer is to process the input received from the input layer or from a previous hidden layer (upstream). These activation functions may vary. Each hidden layer may perform a different function. For example, some hidden layers can be convolutional hidden layers for reducing the dimensionality of the inputs, while other hidden layers can perform more statistical functions such as averaging, max pooling, etc. The magnitude features extracted by the first convolutional neural network and phase features extracted by the second convolutional neural network are combined in a concatenate layer in the concatenate unit. The concatenate unit may include one or more hidden layers or nodes, and a last hidden layer is connected to the output layer, which usually has the same number of nodes as the number of possible object identifications and/or classifications. During training, the model receives the inputs of a training digital wavefront/hologram data example and generates an output identification and/or classification using the bias for each node and the connections between each node and the corresponding weights. The model then compares the generated output with the actual output of the training digital wavefront/hologram data example. Based on the generated output and the actual output of the training digital wavefront/hologram data example, the model then changes the weights associated with each node connection in the respective convolutional neural networks and/or the concatenate unit. In some embodiments, the model also changes the weights associated with each node during training. The training continues until, for example, a predetermined number of training examples being used, an accuracy threshold being reached during training and validation, a predetermined number of validation iterations being completed, etc.

FIG. 3 shows an example information handling system 300 that can be used as a data or information processing system in some embodiments of the invention for performing at least part of the object identification and/or classification method in one or more embodiments of the invention. In one example, the machine learning controller 200 may be part of the information handling system 300.

The information handling system 300 generally comprises suitable components necessary to receive, store, and execute appropriate computer instructions, commands, or codes. The main components of the information handling system 300 are processor 302 and memory (storage) 304. The processor 302 may include one or more CPU(s), MCU(s), controller(s), logic circuit(s), Raspberry Pi chip(s), digital signal processor(s) (DSP), application-specific integrated circuit(s) (ASIC), Field-Programmable Gate Array(s) (FPGA), or any other digital or analog circuitry/circuitries configured to interpret and/or to execute program instructions and/or to process information and/or data. The memory 204 may include one or more volatile memory unit(s) (such as RAM, DRAM, SRAM), one or more non-volatile memory unit(s) (such as ROM, PROM, EPROM, EEPROM, FRAM, MRAM, FLASH, SSD, NAND, and NVDIMM), or any of their combinations. Appropriate computer instructions, commands, codes, information and/or data (e.g., instructions, commands, codes, information and/or data that enable or facilitate the performing of one or more method embodiments of the invention) may be stored in the memory 304. Optionally, the information handling system 300 further includes one or more input devices 306. For example, the input device 306 may include one or more of: keyboard, mouse, stylus, wavefront capturing device (e.g., digital waveform capturing device), microphone, tactile/touch input device (e.g., touch sensitive screen), image/video input device (e.g., imaging system/device 102, camera), etc. Optionally, the information handling system 300 further includes one or more output devices 308. For example, the output device 308 may include one or more of: display (e.g., monitor, screen, projector, etc.), speaker, disk drive, headphone, earphone, printer, additive manufacturing machine (e.g., 3D printer), imaging system/device 102, etc. The display may include a LCD display, a LED/OLED display, or any other suitable display that may or may not be touch sensitive. The information handling system 300 may further include one or more disk drives 312 which may encompass one or more of: solid state drive, hard disk drive, optical drive, flash drive, magnetic tape drive, etc. A suitable operating system may be installed in the information handling system 300, e.g., on the disk drive 312 or in the memory 304. The memory 304 and the disk drive 312 may be operated by the processor 302. Optionally, the information handling system 300 also includes a communication device 310 for establishing one or more communication links (not shown) with one or more other computing devices such as servers, personal computers, terminals, tablets, phones, watches, IoT devices, imaging systems/devices 102, or other wireless or handheld computing devices. The communication device 310 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, an optical port, an infrared port, a USB connection, or other wired or wireless communication interface(s). Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 302, the memory 304, and optionally the input device(s) 306, the output device(s) 308, the communication device 310 and the disk drives 312 are connected with each other through a bus, a Peripheral Component Interconnect (PCI) such as PCI Express, a Universal Serial Bus (USB), an optical bus, or other like bus structure. In one embodiment, some of these components may be connected through a network such as the Internet or a cloud computing network. A person skilled in the art would appreciate that the information handling system 300 shown in FIG. 3 is merely an example and that the information handling system 300 can have different configurations (e.g., additional components, fewer components, etc.) in other embodiments.

The following provides some embodiments of a digital holographic interferometer with deep learning based object (in particular biological tissues) identification and/or classification.

Inventors of the present invention have devised, through research, experiments, and trials, that advancements in optics and computing technologies have enabled digital holograms of physical three-dimensional (3D) objects to be captured and analysed at high speed and achieve close to real time response performance, and that holograms can be displayed with a spatial light modulator to reconstruct a visible image and is suitable for recording, storing, and displaying 3D objects in the digital world. Inventors of the present invention realizes that (i) a hologram comprises high-frequency fringe patterns and is difficult, if not impossible, to recognize with traditional computer vision methods, (ii) in practice, intact extraction of a biological specimen or organ is not feasible, and therefore the object's identity cannot be inferred directly from its outline shape. Inventors of the present invention have devised that a digital holographic interferometer is an effective hologram capturing device to examine the microstructure inside a specimen, and the off-axis configuration of the digital holographic interferometer may simplify the separation of a hologram's zero-order image from the two conjugate virtual and real images in Fourier space. Inventors of the present invention have realized that DFT (discrete Fourier transform) and corresponding IDFT (inverse discrete Fourier transform) are 2D digital signal processing techniques that can be used in digital holography. Inventors of the present invention have found that for interference holograms captured by an existing digital camera, their corresponding frequency spectrums are usually also discrete, and the DFT transforms the interference hologram from the spatial domain to the frequency domain in a discrete manner. Inventors of the present invention have realized that in the frequency domain of an interference hologram, the spectrums of the zero-order image, virtual image, and real image are shifted and separated by the off-axis configuration and so the object wavefront (digital hologram) can be extracted relatively easily. Against this background, inventors of the present invention have devised, through research, experiments, and trials, as some embodiments of the invention, a technique for identifying and/or classifying samples in particular biological samples based on their tissues' digital holograms.

In this embodiment, the system is referred to as an interferometer and an ensemble deep-learning (I-EDL) system, which includes a single-shot off-axis digital holographic interferometer and an ensemble deep learning system for interference hologram capturing and complex-valued object wavefront recognition.

The interferometer provides off-axis holograms with a shifted spectrum of the object's real image that can be easily extracted and processed by the Fourier transform operation (e.g., fast Fourier transform method). Further technical details of the processing can be found in Leal-León et al. “Object wavefield extraction in off-axis holography by clipping its frequency components” and Cuche et al. “Spatial filtering for zero-order and twin-image elimination in digital off-axis holography”, the entire contents of both are incorporated herein by reference. The optical setup is based on the principle of spatial coherence and is installed on a curtain-enclosed optical table. In this example, the coherent light source is a red He—Ne laser with a wavelength of 632.8 nm, and the laser beam is approximately 2 mm in diameter. The object light formed by a laser beam penetrates or passes through the tissue specimen, records related object information. The specimen is moved (e.g., inside a fixed fixture) in the x-y directions to capture hundreds of samples from the specimen. The holograms are captured by a CMOS camera equipped with a Nikon Plan microscope objective.

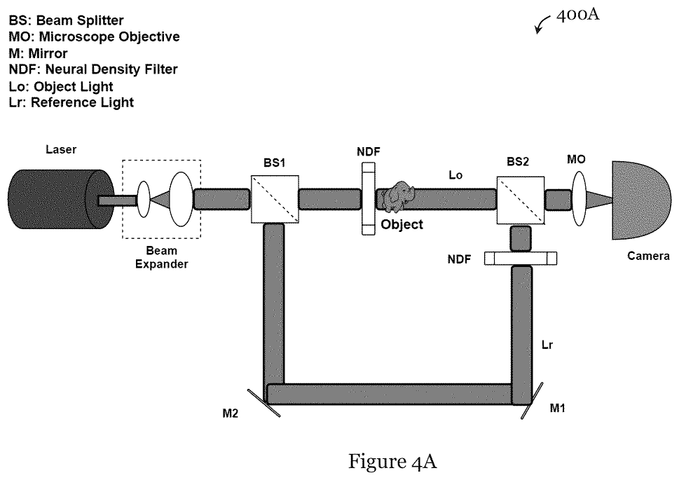

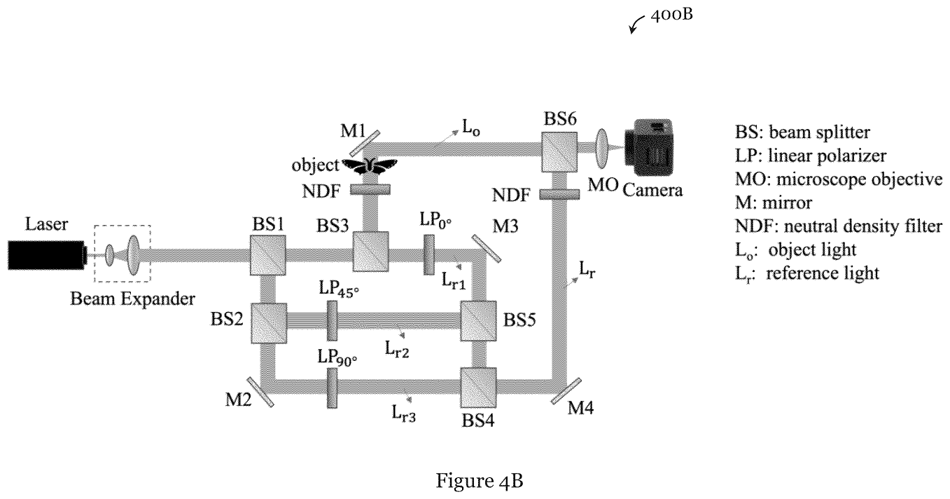

FIG. 4A shows an interferometer system 400A for use in the I-EDL system in one embodiment of the invention. In this embodiment, as shown in FIG. 4A, the system 400A includes a red He—Ne laser source arranged to provide laser (e.g., wavelength of 632.8 nm and about 2 mm laser beam diameter), a beam expander at the output of the laser source, an optical system arranged to manipulate the laser light, and a camera with a microscopic objective MO placed in front of it. The optical system is disposed between the beam expander and the camera (or the microscopic objective MO). A sample object is placed in the path of the object light beam L_{O} between neural density filter NDF and beam splitter BS2. In the optical system: The reference light is separated by a beam splitter BS1, is reflected by two reflectors (mirrors) M1, M2, passes through the neural density filter NDF and then the beam splitter BS2 to interfere with the object light beam (L_{O}). The object light beam L_{O} is separated by a beam splitter BS1, passes through another neural density filter NDF, the object, and then the beam splitter BS2 to interfere with the reference light beam Lᵣ. The neutral density filters are applied in object light beam L_{O} and reference light beam Lᵣ to adjust the light intensity to prevent overexposure. The object light beam L_{O} and reference light beam Lᵣ pass through the microscope objective then into the camera. The interference hologram (e.g., fringe image) of the object is recorded by the camera.

FIG. 4B shows another interferometer system 400B for use in the I-EDL system in one embodiment of the invention. In this embodiment, as shown in FIG. 4B, the system 400B includes a red He—Ne laser source arranged to provide laser (e.g., wavelength of 632.8 nm and about 2 mm laser beam diameter), a beam expander arranged at the output of the laser source, an optical system arranged to manipulate the laser light, and a camera with a microscopic objective MO placed in front of it. The optical system is disposed between the beam expander and the camera (or the microscopic objective MO). A sample object is placed in the path of the object light beam L_{O} between neural density filter NDF and the reflector (mirror) M1 of the optical system. In this optical system: The reference light is first separated by a beam splitter BS1 into two light beams. One of the two light beams is then separated by beam splitter BS2 into two further light beams, which are polarized by two linear polarizers LP_{45°}, LP_{90°} under 45° and 90° respectively. Another one of the two light beams is separated by beam splitter BS3 into two further light beams, one of which is polarized by a linear polarizer LP_{0°} under 0°. The light beams and further light beams are manipulated by beam splitters BS4, BS5 to produce the object light beam L_{O} and the reference light beam Lᵣ, which help to form the interference hologram (e.g., fringe image) of the object for record by the camera. The object light beam L_{O} and reference light beam Lᵣ pass through beam splitter BS6 and the microscope objective MO then into the camera. The optical system includes various reflectors (mirrors) M1-M4 to adjust the light paths (directions). The optical system also includes neutral density filters NDF, one in the path of object light beam Lₒ and another one in the path of the reference light beam Lᵣ, to adjust and prevent the light intensity from overexposure. The interference hologram (e.g., fringe image) of the object is recorded by the camera. The system 400B in this embodiment can obtain interference holograms with different polarization states in a single shot, thus reduces image degradation due to light scatterings and has higher imaging efficiency. Also, the polarization information can help image denoising.

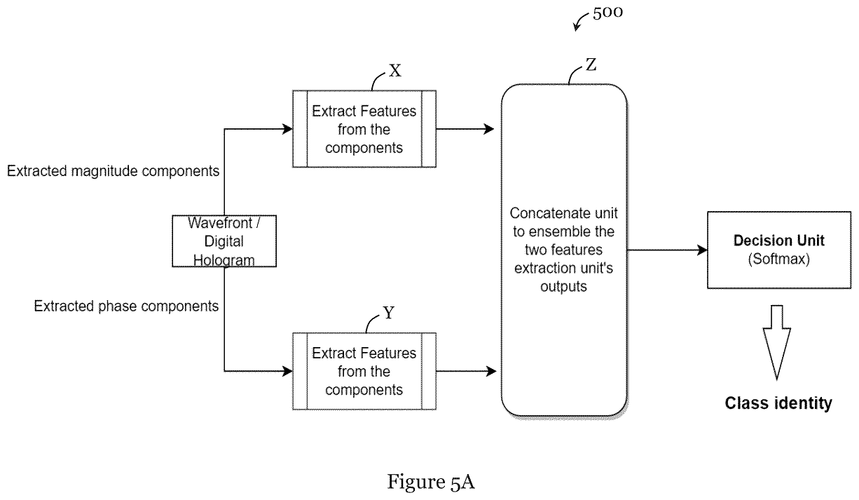

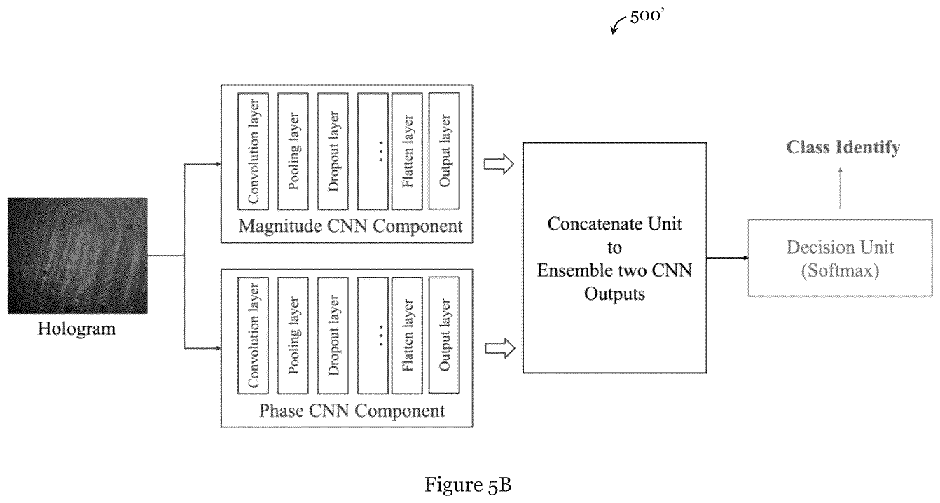

FIG. 5A illustrates a neural-network-based ensemble model 500 of the ensemble deep learning system of the I-EDL system for object classification in the I-EDL system in some embodiments of the invention. The model can also be referred to as a hologram-classifier or a complex-valued wavefront recognition system. The neural-network-based ensemble model 500 may be an ensemble model operable to perform features extractions (magnitude and phase features extractions). As shown in FIG. 5A, the model 500 includes two neural networks, a magnitude neural network X and a phase neural network Y, which receive and process the magnitude and phase components of the digital hologram data or digital hologram respectively. The magnitude neural network X extracts features from the magnitude components of the digital hologram data or digital hologram whereas the phase neural network Y extracts features from the phase components of the digital hologram data or digital hologram. The two neural networks may be structurally the same or similar but trained with different components' (magnitude and phase components') information. The outputs from the two neural networks are combined in a concatenate unit Z to perform object identification and/or classification.

For example, the neural-network-based ensemble model 500′ may be a convolutional-neural-network-based ensemble model, an attention based transformer model, etc. Details of one example of the model 500 of FIG. 5A can be found in Lam et al. “Hologram Classification of Occluded and Deformable Objects with Speckle Noise Contamination by Deep Learning”, the entire contents of which is incorporated herein by reference. Briefly, in this model 500, magnitude and phase data of the digital hologram data or digital hologram is used as the input. The model 500 includes the first and second convolutional neural networks, referred to as the magnitude convolutional neural network and the phase convolutional neural network, which receive and process the magnitude and phase components of the digital hologram data or digital hologram respectively. The magnitude convolutional neural network extracts features from the magnitude components of the digital hologram data or digital hologram whereas the phase convolutional neural network extracts features from the phase components of the digital hologram data or digital hologram. The two networks may be structurally the same or similar but trained with different components' (magnitude and phase components) information. The outputs from the two networks are combined in a concatenate unit to perform object identification and/or classification.

FIG. 5B shows a convolutional neural-network-based ensemble model 500′ of the ensemble deep learning system of the I-EDL system for object classification in the I-EDL system in one embodiment of the invention. The model 500′ can be considered as an example implementation of the general model 500 in FIG. 5A. The model 500′ includes a magnitude convolutional neural network, a phase convolutional neural network, which receive and process the magnitude and phase components of the digital hologram data or digital hologram respectively. The magnitude convolutional neural network extracts features from the magnitude components of the digital hologram data or digital hologram whereas the phase convolutional neural network extracts features from the phase components of the digital hologram data or digital hologram. The outputs of the two networks are combined in a concatenate unit to perform object identification and/or classification. FIG. 5B shows some components of the magnitude convolutional neural network and the phase convolutional neural network in the convolutional-neural-network-based ensemble model 500′. As shown in FIG. 5B, each of the magnitude convolutional neural network and the phase convolutional neural network includes convolution layer(s), pooling layer(s), dropout layer(s), flatten layer(s), and output layer.

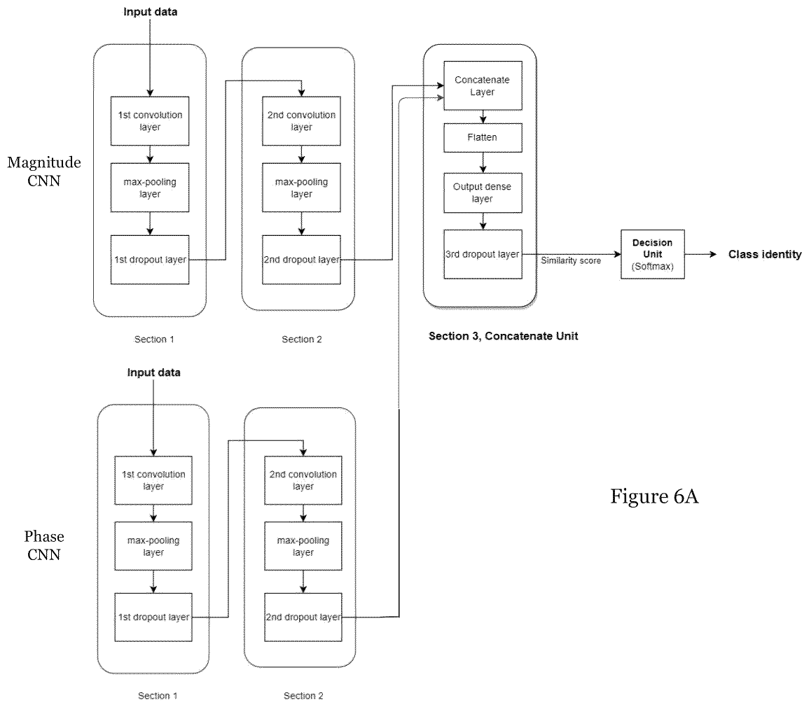

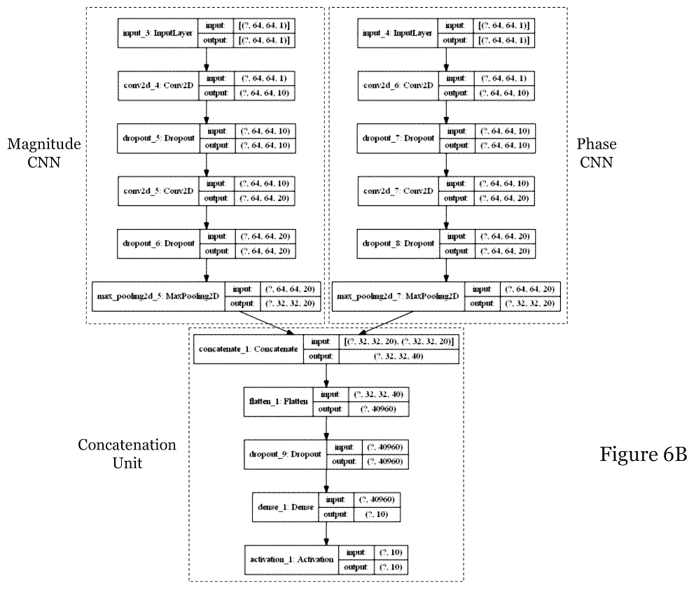

FIGS. 6A and 6B illustrate further details of the model 500′. As shown in FIGS. 6A and 6B, the model 500′ can be can be divided into three sections. Each of the two convolutional neural networks includes respective sections 1 and 2. The two networks have identical structures but different hyper-parameters, containing a convolution layer for local feature extraction, max-pooling, and dropout layers. The model 500′ has a section 3, arranged in a concatenate unit to ensemble output information (magnitude and phase features) from the two networks. The concatenate unit ensembles all the extracted phase features and magnitude features into a combined flatten features vector before fitting into the output dense layer for the decision unit to output the identity of the object associated with the input digital hologram data.

In this embodiment, the hologram-classifier is arranged to identify the tissue object wavefronts (digital holograms) reconstructed from the interference fringe patterns (i.e., raw intensity fringe patterns).

Interference fringe pattern as referred to be interference hologram, f, is a real number quantity and can be obtained as the result of measuring the intensity that results from the linear superposition of a diffracted object wavefront ‘O’ and a reference wavefront ‘R’. Mathematically, the recorded intensity image can be expressed as follows:

Γ′(m,n)=∥R(m,n)+O(m,n)∥² (1)

where Γ′(m, n) is the intensity of the captured hologram with a size of M columns×N rows, R(m, n) is the reference wavefront, and O(m, n) is the object wavefront.

Equation 1 can be expanded as follows:

Γ′(m,n)=∥R(m,n)∥²+∥O(m,n)∥²+O(m,n)R*(m,n)+O*(m,n)R(m,n) (2)

where * is the complex conjugate operation for complex numbers, ∥R(m, n)∥² is the square magnitude of the reference wavefront, and ∥O(m, n)∥² is the square magnitude of the object wavefront. Γ′ is a set of dark and bright fringes that embeds the amplitude and the phase information of the corresponding complex-valued object wavefront.

Discrete Fourier Transform (DFT) can be performed on an interference hologram (e.g., the off-axis interference hologram) and generates the four terms in the frequency domain. The DFT transforms the interference hologram from the spatial domain to the frequency domain in a discrete manner. After performing DFT on Equation 2, Equation 3 below is obtained:

H(u,v)=A²MNδ(u,v)+DFT{∥O(m,n)∥²}+DFT{O(m,n)R*(m,n)+O*(m,n)R(m,n)} (3)

where u, v are the frequency axis, δ is the delta function and A is the reference wave's amplitude.

In the frequency domain, the spectral locations of the frequency components separated by the recorded off-axis hologram provide a relatively easy means to separate specific wavefront information in the Fourier space. The spectrum in the third term can be extracted by a masking method, and the zero-order low-frequency spectrum and the twin image spectrum are removed. The third term extracted spectrum DFT{O(m, n)R*(m, n)} as shown in Equation 3 is centered (for details of the masking method and centering algorithm, refer to Leal-León et al. “Object wavefield extraction in off-axis holography by clipping its frequency components”, and then inverse Fourier transform can be performed to obtain the scaled complex-valued object wavefront AO(m, n) which is the object wavefront multiplied by the reference wave with amplitude A. Optionally, then, a ‘min-max’ normalization algorithm, such as the one disclosed in Cao et al. “A robust data scaling algorithm to improve classification accuracies in biomedical data”, is applied to A(m, n). This method of normalization algorithm scales the values in a data array from [minimum value, maximum value] to [−1, 1] through a linear mapping. It normalizes the effect of the scalar multiplication by the reference wave for recognition. The normalization provides a robust pre-processing method for recognition purposes.

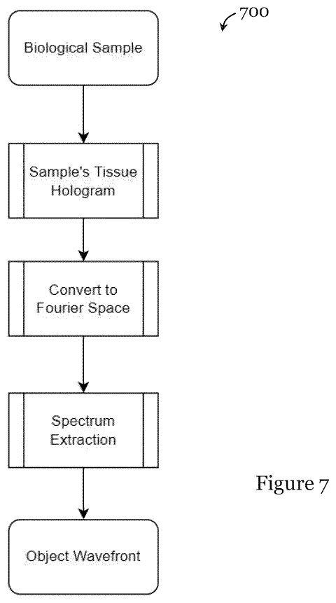

FIG. 7 illustrates a method 700 for obtaining the object wavefront (the digital hologram) for training the neural-network-based ensemble model 500 (including the model 500′). In method 700, first, a tissue interference hologram is captured from the biological samples using the interferometer system. Then, fast DFT is applied to the tissue interference hologram to transform the interference hologram from the spatial domain to the frequency domain. Next, the spectrum of the object wavefront is extracted, and after the extraction, fast IDFT is applied to restore the spectrum into the object wavefront. The object wavefront extracted from the above process is a complex (value) quantity that contains both the magnitude and phase components of the object wave O(m, n), a digital hologram. The method 700 can be applied to multiple samples or interference holograms to obtain a full dataset, which can then be split into an in-training train set and an out-training test set. The model 500 is trained with the train set and tested by the test set. It is found that aberrations have come from dust on optical lenses and mirrors, airy-plaque-like rings out-turn from the system's lenses, etc. In this embodiment, the model 500 can adapt to these background irregularities during the first training stage and continue to perform well in the later recognition stage without substantial or necessary background compensation.

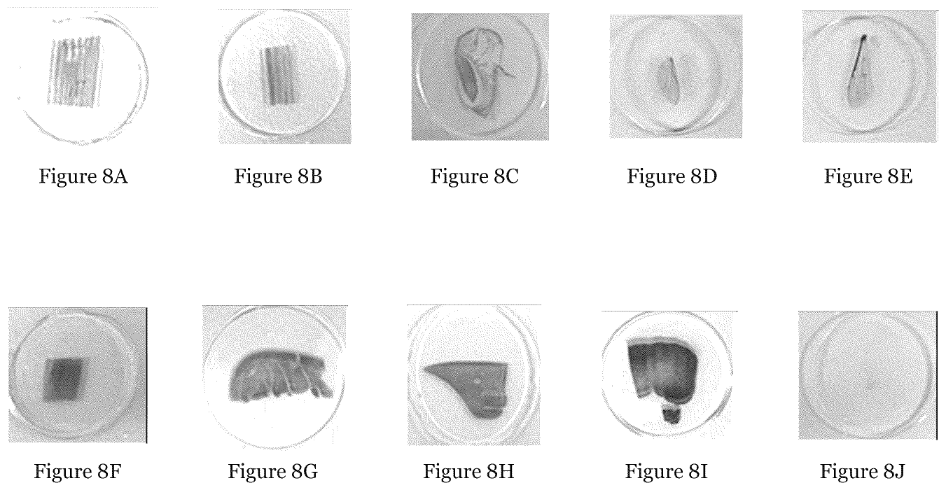

FIGS. 8A to 8J are pictures showing ten types of tissues obtained from ten different flawed biological samples/specimens (8A: Cucurbita Stem; 8B: Pine Stem; 8C: Corn (Zea mays) Seed; 8D: House Fly Wing; 8E: Honeybee Wing; 8F: Bird Feather; 8G: Corpus Ventriculi; 8H: Liver Section; 8I: Lymph Node; 8J: Human Chromosome). These samples/specimens are imaged by the interferometer and can be used to train the model 500 of FIG. 5A. In the following example, they are used to train the model 500′ of FIG. 5B. The tissues in FIGS. 8A to 8J are labelled as classes 1-10 respectively (8A—class 1, 8B—class 2, etc.).

Five hundred interference holograms are captured from tissues of each class of the ten biological specimens and result in a total dataset size of 5000 digital holograms (object wavefronts). In this example. they are used to train the model 500′. Then the trained model 500′ is used to identify the type of biological specimens by recognizing the tissues' digital holograms.

Experiments are performed to test the performance of the trained model 500′.

The system used for testing includes a computer equipped with an i7 Intel processor, Nvidia RTX 2080 Super GPU with 384 Tensor cores arranged to operate model 500′ and the interferometer with a microscope objective placed in front of a CMOS camera. The hologram-classifier uses the same set of hyperparameters of the EDL-IOHC reported in Lam et al. “Hologram Classification of Occluded and Deformable Objects with Speckle Noise Contamination by Deep Learning”. The new optical parameters for the digital holographic interferometric system are shown in Table 1 as below.

TABLE 1
Optical parameters of the digital holographic interferometer system

| Wavelength of light | 632.8 | nm |
|---|---|---|
| Pixel size | 3.45 | um |
| Size of Hologram | 2056 rows and 2546 columns | |
| Off-axis angle | 1.5 | degrees |

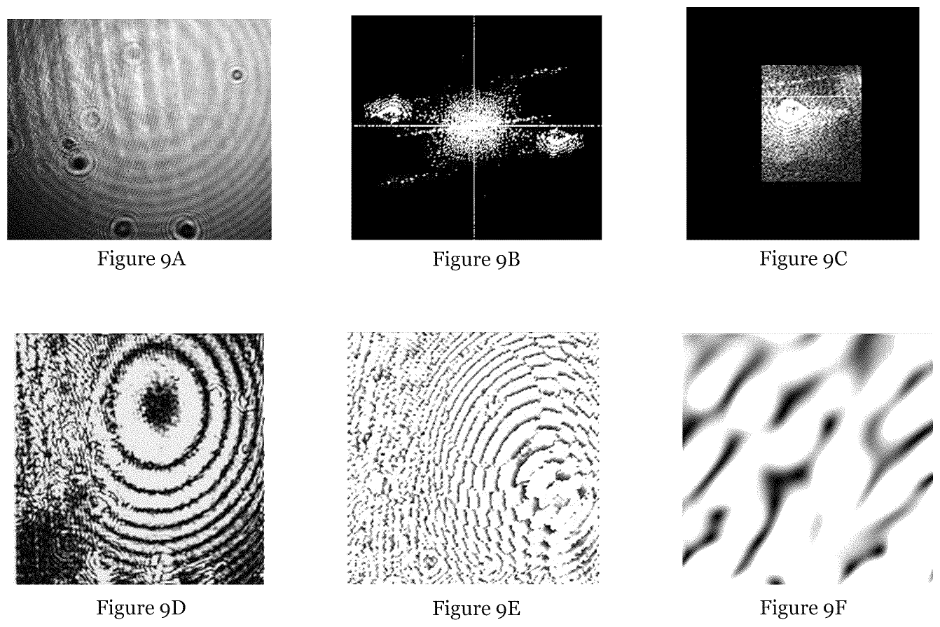

For reference and comparison, a bird feather sample is put under a bright field microscope to image/show the microstructure of the specimen. FIGS. 9A to 9F are images associated with data of the bird feather sample user for training the model′ 500 in the experiment. FIG. 9A shows the interference hologram; FIG. 9A shows all spectrums in Fourier space; FIG. 9C shows a clipped spectrum of the object real image; FIG. 9D shows magnitude component of the object wavefront; FIG. 9E shows phase component of the object wavefront; FIG. 9F illustrates the reconstructed tissue intensity image.

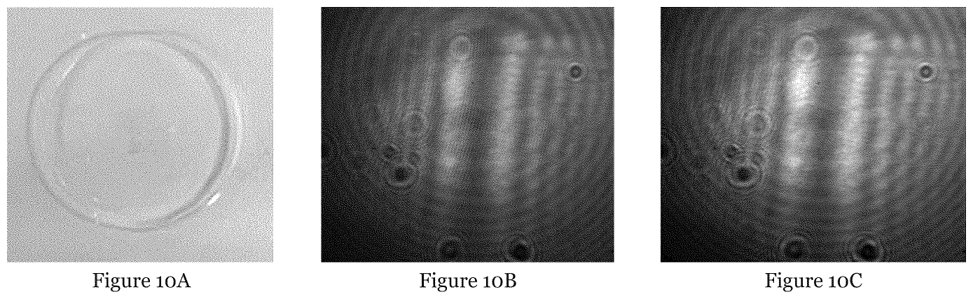

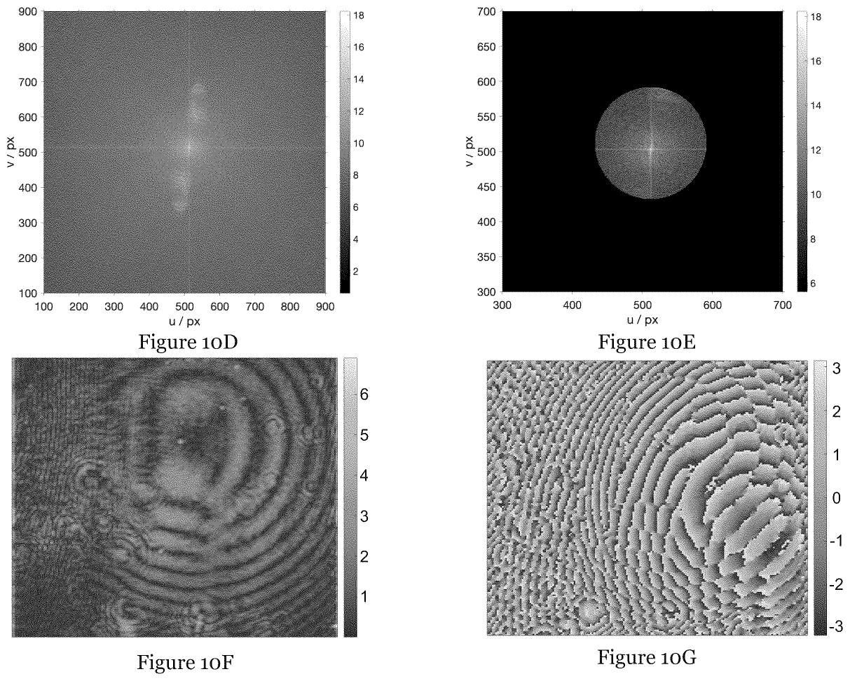

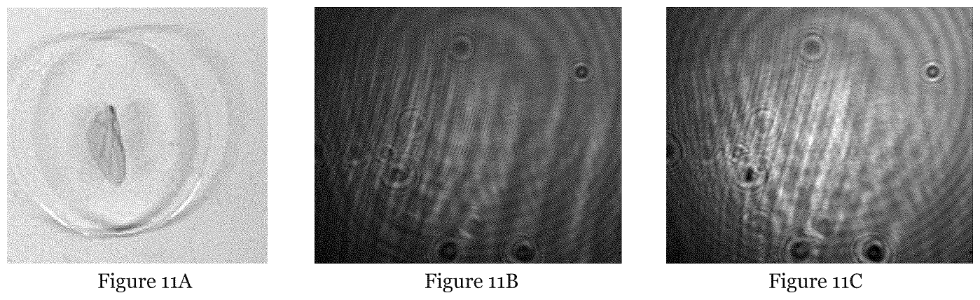

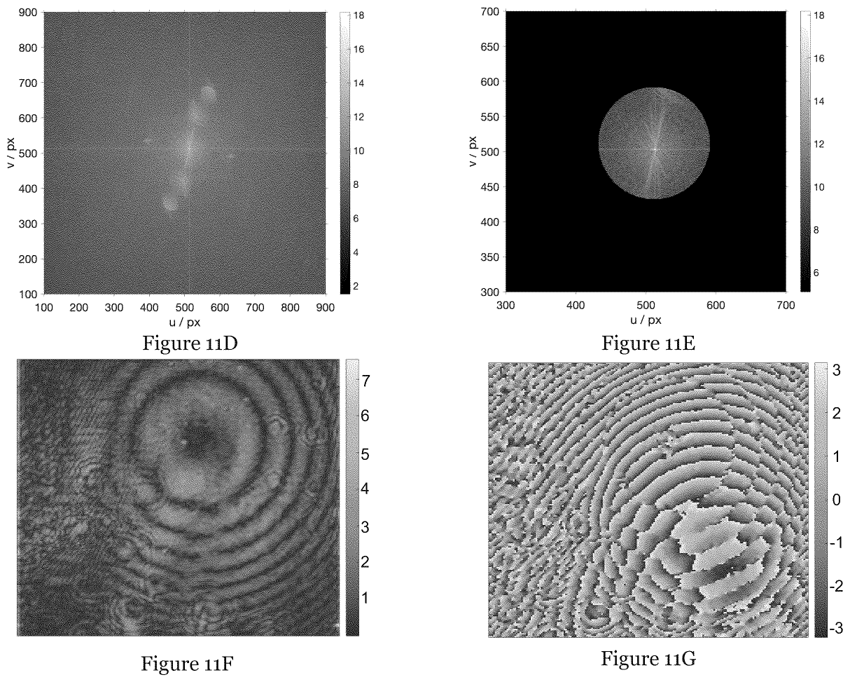

For reference and comparison, a human chromosome sample and a house fly wing sample are tested. FIGS. 10A to 10G shows images/plots related to the human chromosome sample whereas FIGS. 11A to 11G shows images/plots related to the house fly wing sample.

FIG. 10A shows the image of the human chromosome sample used in the experiment, FIG. 10B shows an interference hologram of the human chromosome sample, and FIG. 10C shows a reconstructed tissue image of the human chromosome sample. FIGS. 10D to 10G are plots of the associated spectrums and complex wavefront (10D: full frequency spectrum plot, 10E: clipped frequency spectrum plot, 10F: magnitude of complex wavefront, 10G: phase of complex wavefront). The plots in FIGS. 10D to 10G contain arrays of complex phasors, which cannot be used directly to identify the human chromosome sample.

FIG. 11A shows the image of the house fly wing sample used in the experiment, FIG. 11B shows an interference hologram of the house fly wing sample, and FIG. 11C shows a reconstructed tissue image of the house fly wing sample. FIGS. 11D to 11G are plots of the associated spectrums and complex wavefront (11D: full frequency spectrum plot, 11E: clipped frequency spectrum plot, 11F: magnitude of complex wavefront, 11G: phase of complex wavefront). The plots in FIGS. 11D to 11G contain arrays of complex phasors, which cannot be used directly to identify the house fly wing sample.

In these examples, the human chromosome sample is substantially transparent so its identification is challenging without using a hologram-based classifier; the house fly wing is semi-transparent and the phase information can complement the magnitude information to build better decision boundaries for the model or the neural networks.

In the example experiment, 5000 digital holograms (complex (value) object wavefront) are extracted from the full dataset of 5000 captured interference holograms. Then, 4000 out of the 5000 are taken as the in-training data set, while the remaining out-training data set is used as a test set. The ensemble model 500′ is trained with 3200 in training set data, and the remaining 800 are used as a validation set to stop the training process by an early stopping mechanism. Finally, both the in-training data set and the out-training data set are used to evaluate the model 500′. Training is stopped by the validation set when the change of the validating accuracy is less than 0.01%. In this example, the model 500′ is trained by the data set (with cosine smoothing applied on the phase components), the validation set stops the training epoch, and the actual epoch run is 16. In each epoch, the holograms in the in-training set of the data set are used to train the deep learning structure of the model 500′. The trained structure is then applied to classify the data sets.

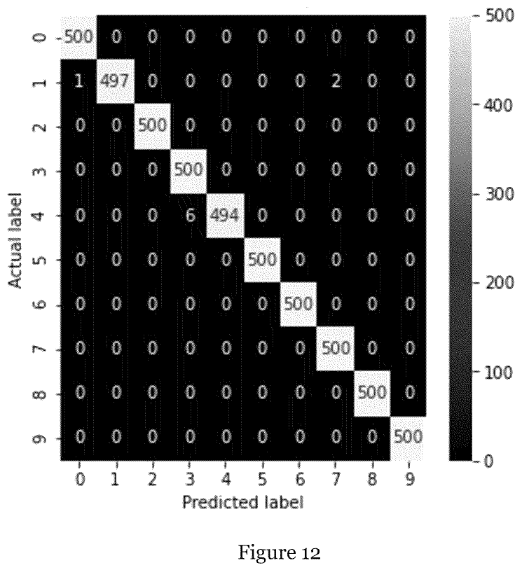

The confusion matrix in FIG. 12 shows that eight out of the ten classes are correct with high overall classification accuracy. In FIG. 12, labels 0-9 correspond to the ten specimen classes as shown in FIGS. 8A-8J (1: Cucurbita Stem; 2: Pine Stem; 3: Corn (Zea mays) Seed; 4: House Fly Wing; 5: Honeybee Wing; 6: Bird Feather; 7: Corpus Ventriculi; 8: Liver Section; 9: Lymph Node; 10: Human Chromosome). The success rates for classifying the out-training test set and the full set are shown in Table 2.

TABLE 2
Success rates for classifying the out-training test
set and the complete data set by the model 500′

| | Success rate of model 500′ |
|---|---|
| | in the classification task |
| Test set | 99.60% |
| Complete set (both out- | 99.82% |
| and in-training sets) | |

The results in Table 2 indicates that in classifying the object, the model 500′ can provide a high success rate of 99.60% for the out-training test set and 99.82% for the entire dataset. The performance is improved compared with the model in Lam et al. “Hologram Classification of Occluded and Deformable Objects with Speckle Noise Contamination by Deep Learning” applied to partially occluded digit objects with speckle noise contamination.

In this embodiment, an off-axis interferometer and an ensemble deep learning (I-EDL) hologram-classifier are used to interpret noisy digital holograms captured from the tissues of flawed biological specimens. The holograms are captured by an interferometer which serves as a digital holographic scanner to scan the tissue with 3D information. A red laser beam penetrates the tissue of the specimen and scans across the x-y directions to capture thousands of off-axis hologram samples for the purpose of training, testing, and recognizing the microstructure of the tissue and hence identifying the identity of the specimens. The method achieves a high success rate of 99.60% in identifying/classifying the specimens through the tissue holograms. The ensemble deep learning hologram-classifier can effectively adapt to optical aberration coming from dust on mirrors and optical lenses aberration such as the Airy-plaque-like rings out-turn from the lenses in the interferometer. The deep learning network can effectively adapt to these irregularities during the training stage and performs well in the later recognition stage without prior optical background compensations. In this embodiment, an intact sample with a full outline shape of the specimen or organ is not required to identify and/or classify the objects' identities. This embodiment demonstrates a paradigm in object identification and/or classification by ensemble deep learning through direct wavefront recognition.

Generally, the deep learning based object identification and/or classification system and method in this invention can be applied, e.g., configured for use, in various applications, including but not limited to one or more of: biological sample identification and/or classification, ocean pollutant (e.g., plastics) identification and/or classification, object (e.g., LCD glasses, lighting luminaire, glass-cover, diamonds; e.g., transparent object, translucent object, semi-transparent object) defect identification and/or classification; etc. The technology in this invention can be applied to holographic microscopy, holographic scanner, tomography scanner, magnetic resonance (MRI) imaging, antenna design, etc.

Although not required, where appropriate, the embodiments described and/or illustrated can be implemented as an application programming interface (API) or as a series of libraries for use by a developer or can be included within another software application, such as a terminal or computer operating system or a portable computing device operating system. Generally, as program modules include routines, programs, objects, components and data files assisting in the performance of particular functions, the skilled person will understand that the functionality of the software application may be distributed across a number of routines, objects, and/or components to achieve the same functionality desired herein.

It will be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computer”, “computing system”, “computing device”, and the like are used, these terms are intended to include (but not limited to) any appropriate arrangement of computer or information processing hardware capable of implementing the function described.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of the invention are provided in the summary and the description. Some embodiments of the invention may include one or more of these optional features (some of which are not specifically illustrated in the drawings). Some embodiments of the invention may lack one or more of these optional features (some of which are not specifically illustrated in the drawings). For example, the object to be identified and/or classified need not be a biological object and can be a non-biological object instead. For example, in some embodiments, the off-axis interferometer may alternatively be an on-axis/inline interferometer. The system and methods of the invention can be applied to other applications, such as identification or classification of defects in objects, identification of infected red blood cells from normal cells, using the same/similar system setup and/or method. Depending on embodiments, the neural-network-based ensemble model may include, e.g., a convolutional-neural-network-based ensemble model, an attention based transformer model, etc.

1. A computer-implemented method for object identification and/or classification, comprising:
receiving digital hologram data of a digital hologram of an object, the digital hologram data comprising phase information and magnitude information; and
processing the digital hologram data based on a neural-network-based ensemble model to identify and/or classify the object.

2. The computer-implemented method of claim 1, wherein the neural-network-based ensemble model comprises an attention based transformer model.

3. The computer-implemented method of claim 1, wherein the neural-network-based ensemble model comprises a convolutional-neural-network-based ensemble model.

4. The computer-implemented method of claim 3, wherein the convolutional-neural-network-based ensemble model comprises a first convolutional neural network arranged to process the magnitude information, a second convolutional neural network arranged to process the phase information, and a concatenate unit arranged to combine magnitude features extracted by the first convolutional neural network and phase features extracted by the second convolutional neural network for identification and/or classification of the object.

5. The computer-implemented method of claim 1, further comprising:
obtaining the digital hologram data of the digital hologram of the object, the obtaining comprises:
receiving a hologram of the object obtained using an imaging device; and
processing the hologram by performing a digital signal processing operation to obtain the digital hologram data.

6. The computer-implemented method of claim 5, wherein the digital signal processing operation comprises:
performing a Fourier transform operation on the hologram;
after the Fourier transform operation, extracting hologram data associated with the object; and
after the extraction, performing an inverse Fourier transform operation on the extracted hologram data to obtain the digital hologram data.

7. The computer-implemented method of claim 5, the imaging device comprises a camera associated with an interferometer.

8. The computer-implemented method of claim 7, wherein the interferometer is an off-axis interferometer and the hologram is an off-axis hologram.

9. The computer-implemented method of claim 1, further comprising outputting or displaying the identification and/or classification result.

10. The computer-implemented method of claim 1, wherein the object comprises a biological tissue sample.

11. The computer-implemented method of claim 10,
wherein the biological tissue sample is sized for microscopy; and/or
wherein the biological tissue sample is incomplete, damaged, or flawed.

12. The computer-implemented method of claim 1, wherein the digital hologram data is associated with an electromagnetic wavefront from the object.

13. The computer-implemented method of claim 1, wherein the digital hologram data is associated with an acoustic wavefront from the object.

14. A system for object identification and/or classification, comprising:
one or more processors arranged to receive digital hologram data of a digital hologram of an object, the digital hologram data comprising phase information and magnitude information; and
process the digital hologram data based on a neural-network-based ensemble model to identify and/or classify the object.

15. The system of claim 14, wherein the neural-network-based ensemble model comprises an attention based transformer model.

16. The system of claim 14, wherein the neural-network-based ensemble model comprises a convolutional-neural-network-based ensemble model.

17. The system of claim 16, wherein the convolutional-neural-network-based ensemble model comprises a first convolutional neural network arranged to process the magnitude information, a second convolutional neural network arranged to process the phase information, and a concatenate unit arranged to combine magnitude features extracted by the first convolutional neural network and phase features extracted by the second convolutional neural network for identification and/or classification of the object.

18. The system of claim 14, wherein the one or more processors are further arranged to:
receive a hologram of the object obtained using an imaging device; and
process the hologram by performing a digital signal processing operation to obtain the digital hologram data.

19. The system of claim 18, wherein the digital signal processing operation performed by the one or more processors includes:
perform a Fourier transform operation on the hologram;
after the Fourier transform operation, extract hologram data associated with the object; and
after the extraction, perform an inverse Fourier transform operation on the extracted hologram data to obtain the digital hologram data.

20. The system of claim 18, further comprising the imaging device, wherein the imaging device comprises a camera associated with an interferometer.

21. The system of claim 20, wherein the interferometer is an off-axis interferometer and the hologram is an off-axis hologram.

22. The system of claim 14, further comprising a display operably connected with the one or more processors for displaying the identification and/or classification result.

23. The system of claim 14, wherein the object comprises a biological tissue sample.

24. The system of claim 14, wherein the digital hologram data is associated with an electromagnetic wavefront from the object.

25. The system of claim 14, wherein the digital hologram data is associated with an acoustic wavefront from the object.

26. A non-transitory computer readable medium comprising computer instructions which, when executed by one or more processors, cause or facilitate the one or more processors to carry out the computer-implemented method of claim 1.
